(19) United States
(12) Patent Application Publication
(10) Pub. No.: US 2007/0035044 A1
(43) Pub. Date: Feb. 15, 2007

(54) Humidifier having a night lamp function

(76) Inventor: Paul Chiu, Taipei County (TW)

Correspondence Address: BIRCH STEWART KOLASCH & BIRCH, PO BOX 747, FALLS CHURCH, VA, 22040-0747, US

(21) Appl. No.: 11/203,233

(22) Filed: Aug. 15, 2005

(51) Int. Cl. B01F 3/04

(52) U.S. Cl. 261/81

(57) ABSTRACT

A humidifier having a night lamp function includes a water storage cylinder of a humidifier made of a transparent material and installs a set of light mixing devices at the bottom of the water storage cylinder. The light mixing devices pass through the bottom of the water storage cylinder and are immersed into a liquid in the water storage tank to mix several color lights. With the changes produced by the waves of the liquid, various color lights are emitted from the pervious water storage cylinder to improve the artistic vision. In addition, the light mixing device can be turned on or off by an independent switch, such that if the liquid level of the water storage tank is low, the electronic devices including the vibrator in the humidifier will be turned off, but the light mixing device will remain lit to provide a night lamp function.

### FIELD OF THE INVENTION

The present invention relates to a humidifier, and more particularly to a humidifier having a night lamp function.

### BACKGROUND OF THE INVENTION

In a dry environment, a large quantity of water may be lost from human respiratory systems, and the original disinfection function of human bodies is weakened, and thus it may cause diseases to our respiratory system. In addition, symptoms such as fatigue, lower vision, and dizziness will be accompanied. In view of this result, a prior art humidifier has been developed for increasing the humidity of an environment.

Referring to FIG. 1 for the prior art humidifier 10, a vibrator 12 installed at the bottom of a water storage tank 11 produces high-frequency vibrations to nebulize a liquid 20 in the water storage tank 11, and a nozzle 13 is installed at the top of the water storage tank 11 for spraying the nebulized moisture and increasing the humidity of an environment. In addition, the prior art humidifier 10 installs a plurality of light emitting diodes (LEDs) 15 at the top of the water storage cylinder 14 at the position connected to the water storage tank 11, and the light emitted by these light emitting diodes 15 is dispersed out of the humidifier 10 through a circular transparent lid 16 on the water storage cylinder 14.

It is worth to point out that the vibrator 12 and the light emitting diode 15 in the prior art humidifier 10 are controlled at the same time. If the power of the humidifier 10 is turned on, the vibrator 12 and the light emitting diode 15 will be turned on at the same time. If the liquid level of the liquid 20 in the water storage tank 11 is low, the vibrator 12 will be turned off automatically to assure the safety and the light emitting diode 15 will be turned off. In other words, the light emitting diode 15 of the prior art humidifier 10 is used for indicating the status of the nebulization and serving as an indicating light only. Further, the light emitting diodes 15 adopt a single color light (for indicating the status only), therefore the light transmitted from the circular transparent lid 16 does not come with too many changes but is very monotonous. Thus, the prior art humidifier can not produce an artistic vision.

### SUMMARY OF THE INVENTION

Therefore, it is a primary objective of the present invention to provide a humidifier having a night lamp function that gives the basic functions of supplying nebulized moisture and increasing the humidity of the environment, as well as providing a light source for a long time or having a night lamp function. The light comes with diversified colors and gives more changes to indicate the status of the humidifier.

To achieve the foregoing objective, the present invention provides a humidifier having a night lamp function that comprises a pervious water storage cylinder, a vibrator, a cover and at least one set of light mixing devices. The pervious water storage cylinder includes a water storage tank for containing a liquid; a vibrator installed at the bottom of the pervious water storage cylinder and adopting the principle of supersonic vibration to nebulize the liquid in the water storage tank; a cover installed at the top of the pervious water storage cylinder and having a nozzle, so that the nebulized moisture can be sprayed out from the nozzle; a light mixing device passing through the bottom of the pervious water storage cylinder and is immersed into the liquid of the water storage tank, and the light mixing device mixes several different lights to produces changes according to the waves of the liquid, and thus the light passing through the water storage cylinder gives various different colors and improve the artistic vision.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a cross-sectional view of a prior art humidifier;

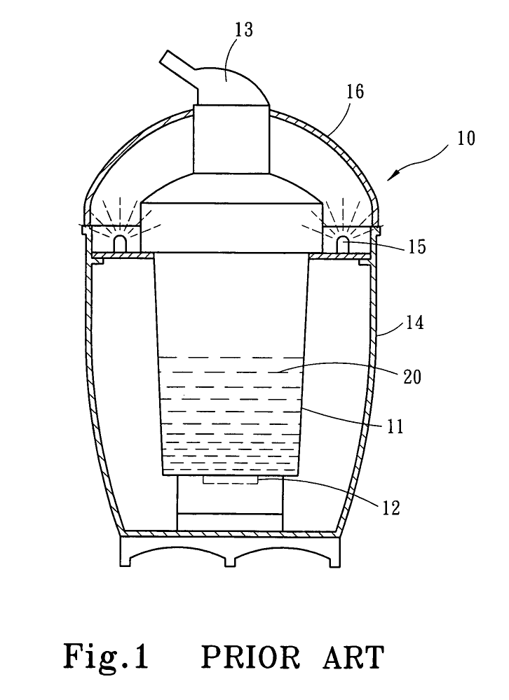

FIG. 2 is an exploded view of a humidifier having a night lamp function according to the present invention;

FIG. 3 is another exploded view of a humidifier having a night lamp function according to the present invention;

FIG. 4 is a perspective view of a humidifier having a night lamp function according to the present invention;

FIG. 5 is a lateral cross-sectional view of a humidifier having a night lamp function according to the present invention; and

FIG. 6 is a schematic view of a liquid nebulization of a humidifier having a night lamp function and a light path of the light emitting diode according to the present invention.

### DETAILED DESCRIPTION OF THE PREFERRED

### EMBODIMENTS

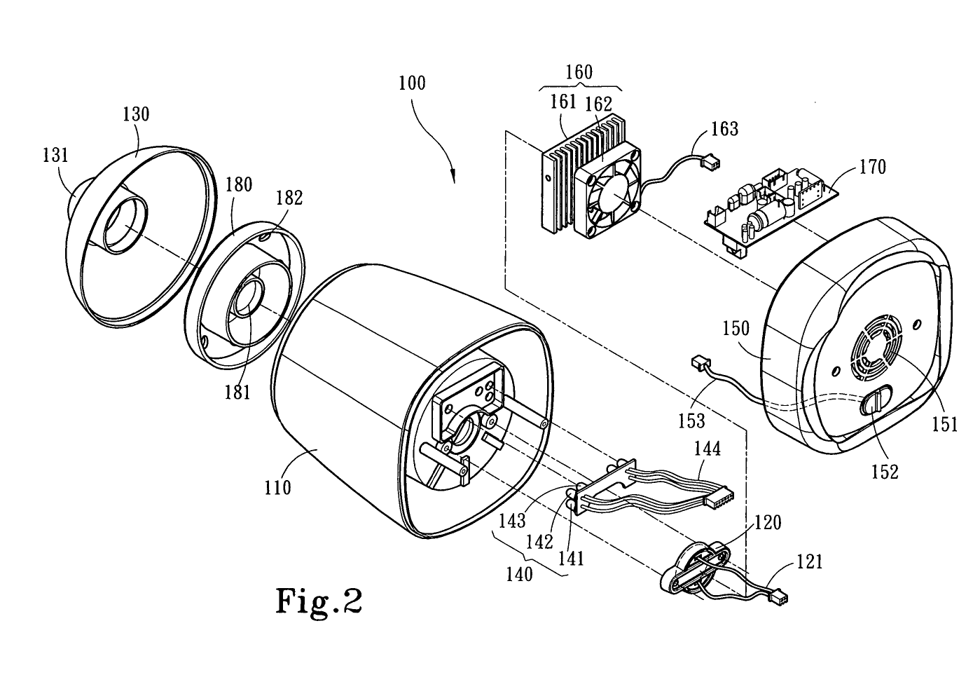

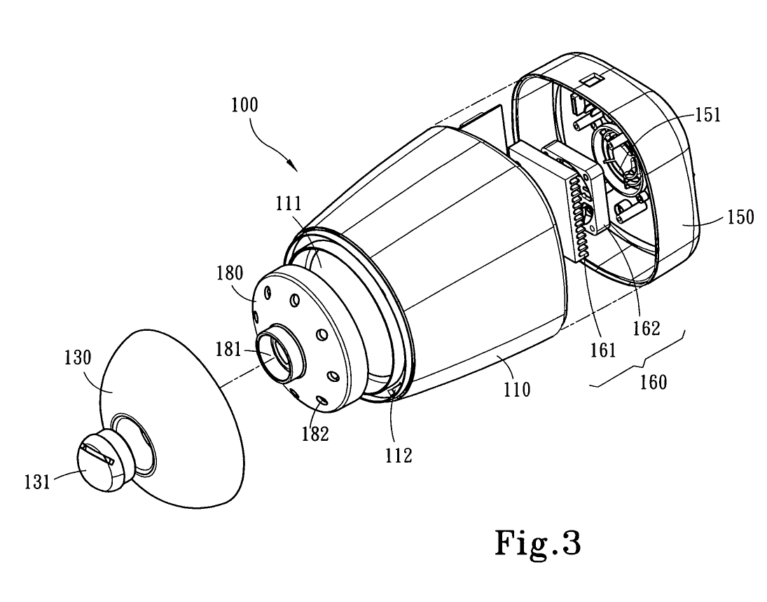

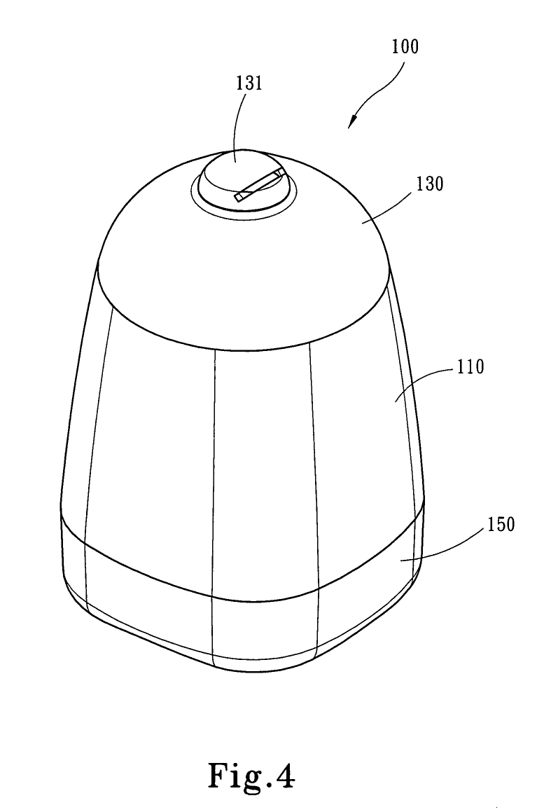

Refer to FIGS. 2 to 5 of a humidifier 100 having a night lamp function according to a preferred embodiment of the present invention, the humidifier 100 comprises a pervious water storage cylinder 110, a vibrator 120, a cover 130 and at least one set of light mixing devices 140.

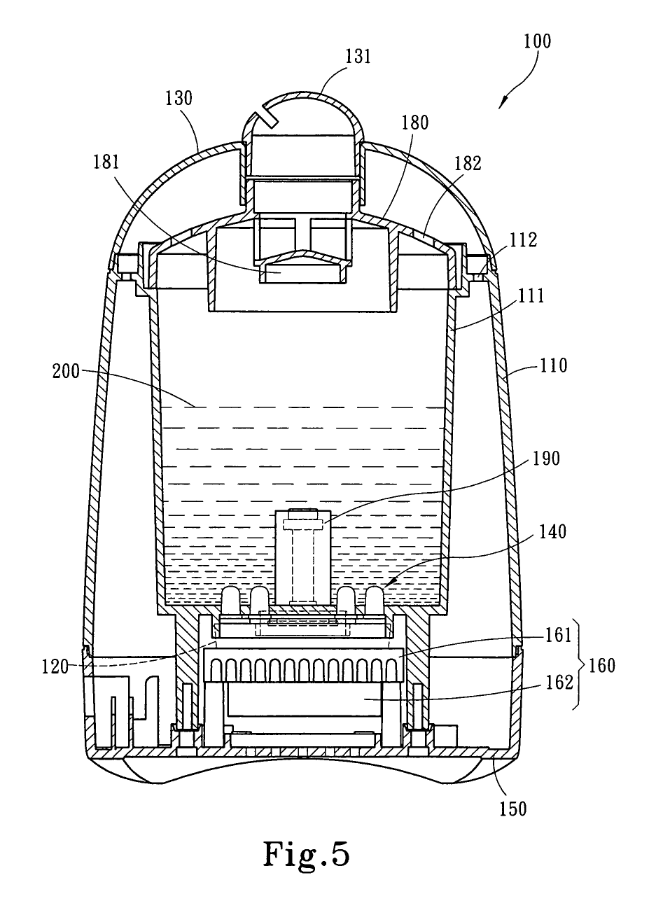

The pervious water storage cylinder 110 includes a water storage tank 111 for containing a liquid 200, and the pervious water storage cylinder 110 could be in a transparent status or a semitranslucent (after the nebulization) status, and the liquid could be water or water with an appropriate quantity of essential oil; the vibrator 120 is installed at the bottom of the pervious water storage cylinder 110 and uses the principle of supersonic vibration to nebulize the liquid 200 in the water storage tank 111; the cover 130 is disposed at the top of the pervious water storage cylinder 110 and includes a nozzle 131, such that the nebulized liquid 200 can be sprayed out from the nozzle 131, and the nozzle 131 can be designed as turnable to change the spraying direction of the nebulized liquid 200; the light mixing devices 140 pass through the bottom of the pervious water storage cylinder 110 and are immersed into the liquid 200 of the water storage tank 111. Referring to FIG. 5 for this preferred embodiment, two sets of light mixing devices 140 are adopted, and each set of light mixing devices 140 is comprised of three pieces of light emitting diodes 141, 142, 143, and these light emitting diodes 141, 142, 143 include a red light emitting diode chip, a green light emitting diode chip, and a blue light emitting diode chip. However, the persons skilled in the art should know that each of the foregoing light emitting diodes 141, 142, 143 is not limited to the mode of a single light emitting chip, but could be a mode of several light emitting chips. In other words, each light emitting diode 141, 142, 143 could be designed to have a red light emitting diode chip, a green light emitting diode chip, and a blue light emitting diode chip. Further, the quantity and the installation positions of the light mixing devices 140 at the bottom of the water storage cylinder 110 should not be limited, but they can be changed according to the actual needs of the design. The area for the light mixing device 140 to pass through the bottom of the pervious water storage cylinder 110 can be coated with a waterproof glue (not shown in the figure) for preventing any leakage of the liquid 200.

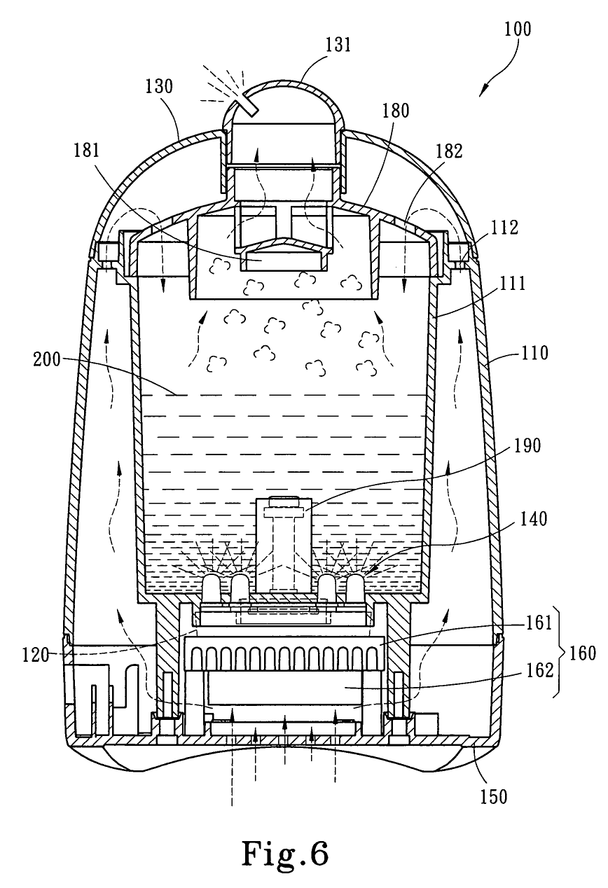

Refer to FIG. 6 for the preferred embodiment. If the vibrator 120 of the humidifier 100 is turned on, the liquid 200 in the water storage tank 111 will be nebulized by the supersonic vibration, and the nebulized liquid 200 will be sprayed out from the nozzle 131 of the cover 130. Since the fine spray of water passing through the nozzle 131 contains a large quantity of anions and water moisture, therefore humidity is increased to the environment constantly to prevent dry skins and irritated eyes. If the liquid 200 contains an essential oil, it also can achieve the effects of relaxing our nerves and recuperating our weariness. However, the humidifier 100 of this preferred embodiment installs a light mixing device 140 to provide a night lamp function in addition to the function of providing nebulized moisture. As to the preferred embodiment, each light emitting diode 141, 142, 143 of the light mixing devices 140 passes through the bottom of the water storage cylinder 110 and is immersed into the liquid 200 of the water storage tank 111, so that the changes of the mixed light of two adjacent light emitting diodes or the mixed light of a single light emitting diode as well as the light produced according to the wave of the liquid 200 (wherein the wave is produced by the supersonic vibration) provide diversified colors for the light emitted from the pervious water storage cylinder 110, and thus further improving the artistic vision. In other words, the present invention mainly uses three primary colors to produce mixed color lights and create a beautiful view according to the waves of the liquid.

Referring to FIGS. 2 to 6 for this embodiment, a base 150 is disposed at the bottom of the water storage cylinder 110 of the humidifier 100 for preventing the components installed at the bottom of the water storage cylinder 110 from being exposed, so as to enhance the safety and appearance of the humidifier 100.

Further, a switch 152 is installed onto an external surface of the base 151 and electrically connected to the light mixing device 140 for independently turning on or off the light mixing device 140. Further, the base 150 can install a control circuit board 170 therein, and the light mixing device 140 and the switch 152 are electrically connected to the control circuit board 170 by electric wires 144, 153 respectively, and the control circuit board 170 can further change the brightness of various different color lights to achieve the mixed light effect.

Further, the vibrator 120 is electrically connected to the control circuit board 170 by the electric wire 121, and the vibrator 120 can install a heat dissipating device 160 comprised of a heat dissipating fin 161 and a fan 162; wherein the heat dissipating fin 161 is installed onto the vibrator 120 and the fan 162 is installed onto the heat dissipating fin 161, and are electrically connected to the control circuit board 170 by the electric wire 163. The fan 162 provides cool air to cool down the heat source of the heat dissipating fin 161 and absorbed from the vibrator 120. The base 150 includes a plurality of heat dissipating slots 151 corresponding to the fan 162 for discharging the heat source from the humidifier 100 to the outside.

Referring to FIGS. 5 and 6, the water storage tank 111 further includes a water level sensor 190 disposed at the bottom of the water storage tank 111 and electrically connected to the control circuit board 170 for detecting the liquid level of the water storage tank 111. If the liquid level of the water storage tank 111 runs low, the electronic devices including the vibrator 120 in the humidifier 100, the vibrator 120, and the fan 162 will be turned off automatically to enhance the safety of its use. It is worth to point out that the light mixing device 140 according to the present invention is turned on or off independently by the control of the switch 152. Therefore, if each electronic device of the humidifier 100 is turned off automatically due to a low liquid level of the water storage tank 111, the light mixing device 140 will still provide a light source to achieve the night light function.

The foregoing level sensor 190 as illustrated in FIGS. 5 and 6, a buoy type sensor is used for its illustration. Of course, the level sensor 190 could be substituted by other electronic or optical sensors instead.

Referring to FIGS. 2 to 6 for the preferred embodiment, the water storage tank 111 of the pervious water storage cylinder 110 installs a water hood 180 and the water hood 180 includes a liquid mist passage 181 disposed at the center of the water hood 180 and interconnected with the nozzle 131 and the water storage tank 111. The water hood 180 includes a plurality of first ventilation holes 182 disposed around the liquid mist passage 181, and the water storage cylinder 110 includes a plurality of second ventilation holes 112 at the top, and some of the air supplied by the foregoing fan 162 flows along the airflow between the water storage cylinder 110 and the water storage tank 111 through the second ventilation holes 112 and the first ventilation holes 182 in sequence and finally is forced to inject into the water storage tank 111. Therefore, the airflow design can guide the nebulized liquid into the liquid mist passage 181 and spray out the nebulized liquid from the nozzle 131.

Further, the humidifier 100 can be connected externally to a timer mist controller (not shown in the figure) for controlling the spraying time. The timer mist controller is a very mature technology and thus will not be described here.

The foregoing cover 130 and the water hood 180 are made of transparent materials, so that some of the light are emitted from the light mixing device 140 or emitted from the cover 130 to provide color changes to enhance the vision.

In summation of the description above, the humidifier having a night lamp function in accordance with the present invention at least has the following advantages:

1. The light emitted by the light mixing device in the humidifier can improve the artistic vision by the mixed light action and the waves of the liquid.

2. The light mixing device in the humidifier is controlled by the independent switch. If the liquid level in the water storage tank is low, the electronic devices including the vibrator in the humidifier will be turned off automatically, but the light mixing device will remain lit to provide a night lamp function.

3. The light mixing device in the humidifier also is controlled by the control circuit board to produce special color lights, so as to provide the effects for beauty treatment and anxiety resistance.

4. An appropriate quantity of essential oil is added to the humidifier, and the vision effect produced by the wave of the liquid can relax a person and recuperate weariness, and effectively cure melancholia patients.

While the invention has been described by means of specific embodiments, numerous modifications and variations could be made thereto by those skilled in the art without departing from the scope and spirit of the invention set forth in the claims.

What is claimed is:

1. A humidifier having a night lamp function, comprising:
a pervious water storage cylinder, having a water storage tank for containing a liquid;
a vibrator, installed at the bottom of said pervious water storage cylinder and applicable to a supersonic vibration for nebulizing said liquid in said water storage tank;
a cover, installed at the top of said pervious water storage cylinder and including a nozzle, such that said nebulized liquid is sprayed out from said nozzle; and
at least one set of light mixing devices, passing through the bottom of said pervious water storage cylinder and being immersed into said liquid of said water storage tank, and said light mixing device mixes a plurality of color lights and produces various changes according to the waves of said liquid, so that various color lights are emitted from said pervious water storage cylinder.

2. The humidifier having a night lamp function of claim 1, wherein said set of light mixing devices comprises at least three pieces of light emitting diodes, and said light emitting diodes comprise a red light emitting diode chip, a green light emitting diode chip, and a blue light emitting diode chip.

3. The humidifier having a night lamp function of claim 1, wherein said set of light mixing devices is comprised of at least one light emitting diode, and said light emitting diode simultaneously includes a red light emitting diode chip, a green light emitting diode chip and a blue light emitting diode chip.

4. The humidifier having a night lamp function of claim 1, further comprising a base installed at the bottom of said pervious water storage cylinder and a switch installed onto an external surface of said base, and said switch being electrically coupled with said set of light mixing devices for independently turning on or off said set of light mixing devices.

5. The humidifier having a night lamp function of claim 4, further comprising a control circuit board installed in said base, and said set of light mixing devices being electrically coupled to said switch through said control circuit board, and said control circuit board being capable of changing the brightness of various color lights for achieving the effect of changing mixed lights.

6. The humidifier having a night lamp function of claim 5, further comprising a heat dissipating device made of a heat dissipating fin and a fan, wherein said heat dissipating fin is installed onto said vibrator and said fan is installed onto said heat dissipating fin, and said fan is electrically coupled to said control circuit board.

7. The humidifier having a night lamp function of claim 6, further comprising a level sensor installed at the bottom of said water storage tank and electrically coupled to said control circuit board.

8. The humidifier having a night lamp function of claim 6, further comprising a water hood installed on said water storage tank of said water storage cylinder, and said water hood includes a liquid mist passage disposed at the center of said water hood and interconnected with said nozzle and said water storage tank.

9. The humidifier having a night lamp function of claim 8, wherein said water hood comprises a plurality of first ventilation holes arranged around said liquid mist passage, and said water storage cylinder comprises a plurality of second ventilation holes disposed at the top of said water storage cylinder, and the air supplied by said fan flows through said second ventilation holes and said first ventilation holes in sequence and is forced to inject into said water storage tank for guiding said nebulized liquid into said liquid mist passage.

10. The humidifier having a night lamp function of claim 8, wherein said water hood and said cover are made of a transparent material.
